(19) United States
(12) Patent Application Publication
(10) Pub. No.: US 2013/0051804 A1
(43) Pub. Date: Feb. 28, 2013

(54) OFDM OPTICAL TRANSMITTER AND TRANSMISSION METHOD, AND OFDM OPTICAL RECEIVER AND RECEPTION METHOD

(71) Applicants: Hwan Seok CHUNG, Daejeon (KR); Sun Hyok CHANG, Daejeon (KR)

(72) Inventors: Hwan Seok CHUNG, Daejeon (KR); Sun Hyok CHANG, Daejeon (KR)

(73) Assignee: Electronics and Telecommunications Research Institute, Daejeon (KR)

(21) Appl. No.: 13/589,436

(22) Filed: Aug. 20, 2012

(30) Foreign Application Priority Data
Aug. 23, 2011 (KR) 10-2011-0084215

(51) Int. Cl. H04J 14/00

(52) U.S. Cl. 398/79

(57) ABSTRACT

Disclosed is an orthogonal frequency division multiplexing (OFDM) optical transmitter including a signal size adjustor for amplifying plural data signals modulated based on an OFDM scheme with different amplification rates so that each data signal is amplified according to a size of the corresponding data signal. Accordingly, it is possible to reduce a peak-to-average power ratio, and thus a nonlinear phenomenon generated in an optical line can be reduced and the quality of an OFDM optical signal can be improved.

### CROSS-REFERENCE TO RELATED APPLICATIONS

This application claims priority to and the benefit of Korean Patent Application No. 10-2011-0084215 filed in the Korean Intellectual Property Office on Aug. 23, 2011, the entire contents of which are incorporated herein by reference.

### TECHNICAL FIELD

The present invention relates to an optical transceiver and an optical transmission/reception method for super-high speed data signal transmission, and more particular to an OFDM optical transceiver and an optical transmission/reception method.

### BACKGROUND ART

Internet traffic has consistently increased due to, particularly, the advent of an IP based service such as a smart phone, cloud computing and the like, such that a wide area distribution of a network becomes necessary. A wavelength division multiplexed optical transmission system for multiplexing several wavelengths within one optical fiber and then transmitting the wavelengths is recognized as a means capable of most efficiently accepting the increased traffic. In order to efficiently transmit the increased traffic, various modulation schemes appear based on a high speed channel as well as an increase in a transmission rate per channel.

Meanwhile, a signal having a speed equal to or larger than 40 G per wavelength appears to meet a bandwidth demand at points where data traffic is concentrated such as high performance computing, a server, a data center, an enterprise network, an Internet exchange center and the like. In order to transmit such a high speed signal, an optical transmitter uses a phase shift key (PSK) modulation scheme in which a phase of an optical signal is modulated or a quadrature phase shift key (QPSK) modulation scheme in which two or more bits can be transmitted for one symbol. Here, the PSK or the QPSK modulation scheme has advantages of overcoming limitations of an optical/electrical device in a high speed optical transmission system and restraining restrictive factors generated in an optical line.

In general, since a PSK signal or a QPSK signal is carried on one carrier and then transmitted, a reception side should compensate for a chromatic dispersion and a polarization mode dispersion, for each channel, generated in the optical line according to an increase in a transmission rate. In order to solve such a disadvantage in which the reception side should compensate for the signal, an orthogonal frequency division multiplexing (OFDM) optical transmitter in which a transmitter divides a high speed signal into a plurality of low speed signals, carries the signals on a plurality of carriers, and then transmits the signals, is proposed. The OFDM optical transmitter converts a high speed data bit of a data signal received in serial to a low speed parallel data bit, and performs a symbol insertion and a conversion to a signal in a time domain. The OFDM optical transmitter converts the data signal in a digital signal type converted to the signal in the time domain to an analog signal. Next, a sampled analog signal is modulated to an optical signal and then transmitted through an optical fiber.

The quality of the OFDM optical signal may be deteriorated through an experience of a nonlinear phenomenon such as an self-phase modulation (SPM), a cross-phase modulation (XPM) and the like while being transmitted through the optical fiber, and the OFDM optical signal having a large difference between average power and peak power requires a compensation countermeasure against the nonlinear phenomenon since the signal is seriously affected by the nonlinear phenomenon within the optical fiber.

### SUMMARY OF THE INVENTION

An exemplary embodiment of the present invention provides an orthogonal frequency division multiplexing (OFDM) optical transmitter including: a signal size adjustor for amplifying plural data signals modulated based on an OFDM scheme with different amplification rates so that each data signal is amplified according to a size of the corresponding data signal.

The amplification rate may be relatively smaller as the size of the data signal is larger.

Input/output characteristics of the signal size adjustor may be defined by a log function having a parameter corresponding to a value of an input signal.

The OFDM optical transmitter may further include a serial-to-parallel converter for converting a serial data bit to a parallel data bit; a symbol mapper for performing symbol mapping on the parallel data bit; a training symbol inserter for inserting a training symbol in each of the plural data signals to which the parallel data bit is mapped; and an inverse fast Fourier transform unit for performing an inverse fast Fourier transform on the data signal in which the training symbol is inserted.

The signal size adjustor may amplify data signals output from the inverse fast Fourier transform unit.

The OFDM optical transmitter may further include a parallel-to-serial converter for converting a parallel data signal output from the signal size adjustor to a serial data signal; a guard interval inserter for inserting a guard interval in a data signal output from the parallel-to-serial converter; and a digital-to-analog converter for converting a data signal output from the guard interval inserter to an analog signal.

Another exemplary embodiment of the present invention provides an OFDM optical receiver including: a signal size adjustor for amplifying data signals converted to electrical signals from received optical signals modulated based on an OFDM scheme with different amplification rates so that each of the data signals is amplified according to a size of the corresponding data signal.

The amplification rate may be relatively larger as the size of the data signal is larger.

Input/output characteristics of the signal size adjustor may be defined by an inverse function of a log function having a parameter corresponding to a value of an input signal.

The OFDM optical receiver may further include an analog-to-digital converter for performing an analog-to-digital conversion on the signal converted to the electrical signal from the modulated optical signal to output a serial data signal; a guard interval remover for removing a guard interval from the serial data signal; and a serial-to-parallel converter for converting a serial data signal output from the guard interval remover to a parallel data signal.

The signal size adjustor may amplify data signals output from the serial-to-parallel converter.

The OFDM optical receiver may further include a fast Fourier transform unit for performing a fast Fourier transform on a data signal output from the signal size adjustor; a channel equalizer for performing a channel equalization on a data signal output from the fast Fourier transform unit; a symbol demapper for performing symbol demapping on a data signal output from the channel equalizer; and a parallel-to-serial converter for converting a parallel data bit from the symbol demapper to a serial data bit.

Yet another exemplary embodiment of the present invention provides an OFDM optical transmission method including: generating plural data signals modulated based on an OFDM scheme; and amplifying the plural data signals with different amplification rates so that each of the data signals is amplified according to a size of the corresponding data signal.

The amplification rate may be relatively smaller as the size of the data signal is larger.

The amplifying of the plural data signals may include amplifying each of the data signals according to input/output characteristics defined by a log function having a parameter corresponding to a value of an input signal.

The OFDM optical transmission method may further include converting the amplified data signals to optical signals.

Still another exemplary embodiment of the present invention provides an OFDM optical reception method including: receiving optical signals modulated based on an OFDM scheme; and amplifying data signals converted to electrical signals from the received optical signals with different amplification rates so that each of the data signals is amplified according to a size of the corresponding data signal.

The amplification rate may be relatively larger as the size of the data signal is larger.

The amplifying of the data signals may include amplifying each of the data signals according to input/output characteristics defined by an inverse function of a log function having a parameter corresponding to a value of an input signal.

The OFDM optical reception method may further include performing a fast Fourier transform on the amplified data signals; and performing a symbol demapping on the fast Fourier transformed data signals.

According to exemplary embodiments of the present invention, it is possible to amplify signals modulated based on an OFDM scheme in an OFDM optical transmission process with different amplification rates according to sizes of the signals, and thus reduce a peak-to-average power ratio, thereby reducing a nonlinear phenomenon generated in an optical line and improving the quality of an OFDM optical.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating an OFDM optical transmitter according to an exemplary embodiment of the present invention.

FIG. 2 is a graph illustrating an example of input/output characteristics of a signal size adjustor 130.

FIG. 3 is a diagram illustrating an OFDM optical receiver according to an exemplary embodiment of the present invention.

FIG. 4 is a flowchart illustrating an OFDM optical transmission method according to an exemplary embodiment of the present invention.

FIG. 5 is a flowchart illustrating an OFDM optical reception method according to an exemplary embodiment of the present invention.

FIG. 6A illustrates probability distributions of sizes of OFDM signals before and after the sizes of the signals are adjusted according to exemplary embodiments of the present invention.

FIG. 6B illustrates a CCDF graph of a peak-to-average power ratio according to exemplary embodiments of the present invention.

FIG. 7 illustrates a capability of a signal measured after an OFDM signal is transmitted through a single mode optical fiber according to exemplary embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

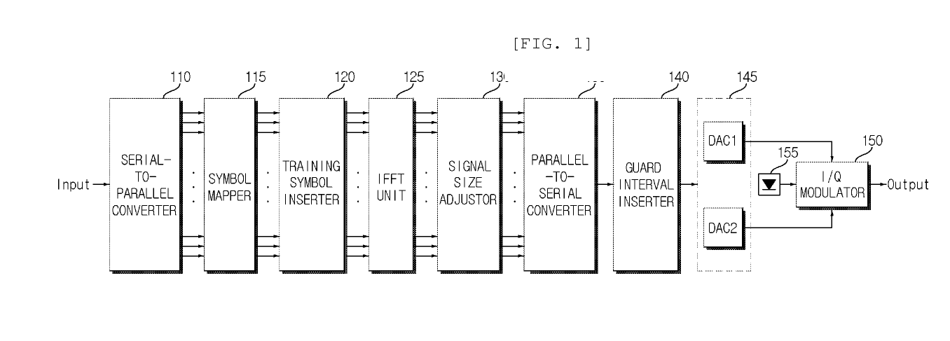

FIG. 1 is a diagram illustrating an OFDM optical transmitter according to an exemplary embodiment of the present invention. An OFDM optical transmitter 100 according to the exemplary embodiment of the present invention may include a serial-to-parallel converter 110, a symbol mapper 115, a training symbol inserter 120, an inverse fast Fourier transform unit 125, a signal size adjustor 130, a parallel-to-serial converter 135, a guard interval inserter 140, a digital-to-analog converter 145, an I/Q (Inphase/Quadrature) modulator 150, and a light source 155.

Referring to FIG. 1, the serial-to-parallel converter 110, the symbol mapper 115, the training symbol inserter 120, and the inverse fast Fourier transform unit 125 modulate an input high speed serial data bit based on an orthogonal frequency division multiplexing (OFDM) scheme.

More specifically, the serial-to-parallel converter 110 converts the input high speed serial data bit to a low speed parallel data bit. The symbol mapper 115 rearranges data bits included in each data signal, and then performs a symbol mapping on the rearranged data bits according to a preset modulation format. The preset modulation format may be a quadrature phase shift keying (QPSK) or a quadrature amplitude modulation (QAM), but the modulation format is not limited thereto. The training symbol inserter 120 inserts a training symbol in each of the plural data signals into which the data bits are mapped. The training symbol refers to a value already known in every predetermined period, and is inserted to prevent an error of a symbol mapped by the symbol mapper 115. The inverse fast Fourier transform unit 125 performs an inverse fast Fourier transform on the data signal output from the training symbol inserter 120 so that the data signal is converted to a signal in a time domain. The data signals output from the inverse fast Fourier transform unit 125 are carried on different carriers, and respective carriers have orthogonality. The data signal output from the inverse fast Fourier transform unit 125 corresponds to the signal modulated based on the OFDM scheme.

The signal size adjustor 130 amplifies the plural data signals, which are modulated based on the OFDM scheme, output from the inverse fast Fourier transform unit 125 with different amplification rates according to sizes of the data signals. That is, the signal size adjustor 130 adjusts amplitudes of the plural data signals output from the inverse fast Fourier transform unit 125 according to the sizes of the data signals and then outputs the data signals with adjusted amplitudes. In this embodiment, the signal size adjustor 130 serves to reduce a peak-to-average power ratio of the OFDM signal. The signal size adjustor 130 will be described below in more detail.

The parallel-to-serial converter 135 converts the low speed parallel data signal output from the signal size adjustor 130 to a high speed serial data signal. The guard interval inserter 140 inserts a guard interval in the data signal output from the parallel-to-serial converter 135. A cyclic prefix can be inserted as the guard interval. The cyclic prefix is inserted between symbols and between data bits in order to prevent inter-channel interference.

The digital-to-analog converter 145 converts the serial data signal output from the guard interval inserter 140 to an analog signal. At this time, a real part and an imaginary part of a complex signal generated after the inverse fast Fourier transform by the inverse fast Fourier transform unit 125 are input to the digital-to-analog converter 145, and the digital-to-analog converter 145 performs a digital-to-analog conversion on each of the real part and the imaginary part.

The I/Q modulator 150 performs an optical modulation for an I (Inphase) component and a Q (Quadrature) component of the analog signal output from the digital-to-analog converter 145 to output the analog signal as an optical signal. More specifically, the I/Q modulator 150 generates the optical signal by carrying the signal output from the digital-to-analog converter 145 on the light source 155 and then modulating the signal. The optical signal output from the I/Q modulator 150 is transmitted through an optical line.

Hereinafter, the signal size adjustor 130 will be described in detail. The signal size adjustor 130 amplifies input data signals with different amplification rates according to sizes of the data signals, thus reducing a peak-to-average power ratio of the OFDM optical signal transmitted through the OFDM optical transmitter 100. In this specification, the term of “amplification” corresponds to a concept including an action of decreasing the size of the signal as well as an action of increasing the amplitude of the signal. For example, “amplification” means the action of increasing the amplitude of the signal when the amplification rate is larger than “1”, and means the action of decreasing the amplitude of the signal when the amplification rate is smaller than “1”.

The amplification rate of the signal size adjustor 130 is set to a relatively smaller value as the size of the data signal is larger and set to a relatively larger value as the size of the data signal is smaller, so that the peak-to-average power ratio is reduced. That is, the signal size adjustor 130 can reduce the peak-to-average power ratio by amplifying a small sized signal with a large amplification rate and amplifying a large sized signal with a small amplification rate for the plural data signals.

In order to enable the amplification rate to be smaller as the size of the signal is larger and to be larger as the size of the signal is smaller, input/output characteristics of the signal size adjustor 130 may be defined, for example, by a log function having a parameter corresponding to a value of an input signal. The following equation is a function showing an example of the input/output characteristics.

[Equation 1]

y=sgn(x)*xₚₑₐₖ*log(1+μ*abs(x)/xₚₑₐₖ)/log(1+μ) (1)

In Equation 1, x and y denote an input signal and a corresponding output signal of the signal size adjustor 130, respectively, xₚₑₐₖ denotes an input signal having a maximum size, abs( ) denotes an absolute value, and sgn( ) denotes a sign. μ denotes a constant for varying the input/output characteristics, and is preset to a proper value.

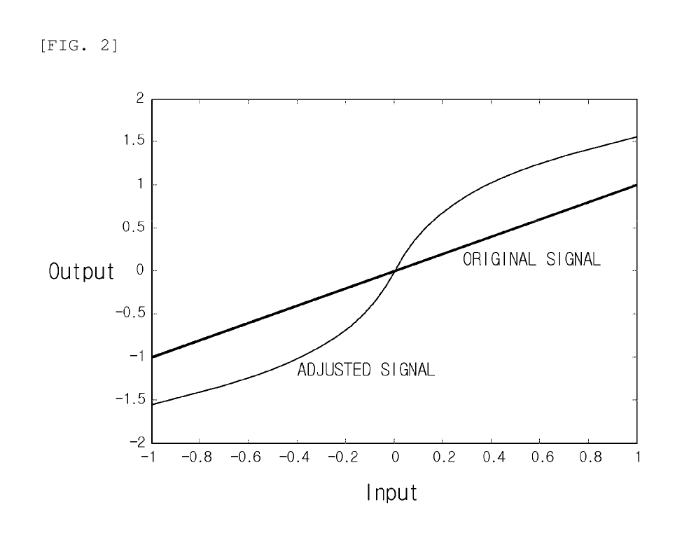

FIG. 2 is a graph showing the input/output characteristics of the signal size adjustor 130 according to Equation 1. When there is no signal size adjustor 130 or the amplification rate of the signal size adjustor 130 is “1” regardless of the size of the input signal, the input/output characteristics show a straight line (original signal) as shown in FIG. 2. By defining the input/output characteristics of the signal size adjustor 130 by using the log function having the parameter corresponding to the value of the input signal, the amplification rate increases as the size of the input signal is smaller and the amplification rate decreases as the size of the input signal is larger as shown in FIG. 2 (adjusted signal). Through a change in a value of μ in Equation 1, a shape of the graph showing the input/output characteristics may be changed.

As described above, the signal size adjustor 130 outputs the plural data signals after amplifying the small sized signal with the large amplification rate and amplifying the large sized signal with the small amplification rate, so that peak power of the OFDM signal may be decreased while average power of the OFDM signal is maintained. Accordingly, the peak-to-average power ratio can be reduced.

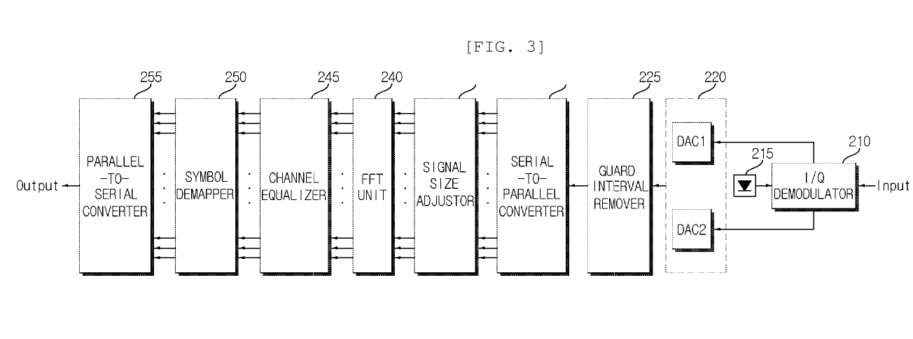

FIG. 3 is a diagram illustrating an OFDM optical receiver according to an exemplary embodiment of the present invention. The OFDM optical receiver 200 according to the exemplary embodiment of the present invention includes an I/Q demodulator 210, a light source 215, an analog-to-digital converter 220, a guard interval remover 225, a serial-to-parallel converter 230, a signal size adjustor 235, a fast Fourier transform unit 240, a channel equalizer 245, a symbol demapper 250, and a parallel-to-serial converter 255. The OFDM optical receiver 200 according to the exemplary embodiment of the present invention receives an optical signal modulated based on the OFDM scheme from the OFDM optical transmitter 100 described with reference to FIG. 1.

The I/Q demodulator 210 converts a received optical signal to an I (Inphase) signal and a Q (Quadrature) signal corresponding to electrical signals by using the light source 215. The I/Q demodulator 210 may include an optical hybrid and a photodetector. The I signal and the Q signal are input to the analog-to-digital converter 220. The analog-to-digital converter 220 outputs a serial data signal by sampling an input analog signal.

The guard interval remover 225 removes a guard interval inserted by a transmission side from the input serial data signal. Although not illustrated in FIG. 3, it is possible to perform a synchronization process between a time and a frequency before the guard interval remover 225. The serial-to-parallel converter 230 converts a high speed serial data signal output from the guard interval remover 225 to a low speed parallel data signal.

The signal size adjustor 235 amplifies plural data signals output from the serial-to-parallel converter 230 with different amplification rates according to sizes of corresponding data signals so that the adjustment of the sizes of the data signals corresponds to the adjustment of the sizes of the data signals by the signal size adjustor 130 of the OFDM optical transmitter 100. As described above, the amplification rate of the signal size adjustor 130 of the OFDM optical transmitter 100 is set to a relatively smaller value as the size of the data signal is larger and set to a relatively larger value as the size of the data signal is smaller. Accordingly, on the contrary to the amplification rate of the signal size adjustor 130, the amplification rate of the signal size adjustor 235 of the OFDM optical receiver 200 is set to a relatively larger value as the size of the data signal is larger, and set to a relatively smaller value as the size of the data signal is smaller. That is, the signal size adjustor 235 outputs the plural data signals after amplifying the large sized signal with the large amplification rate and amplifying the small sized signal with the small amplification rate, so that it is possible to offset the adjustment of the sizes of the data signals by the signal size adjustor 130 of the OFDM optical transmitter 100. To this end, input/output characteristics of the signal size adjustor 235 may be defined by an inverse function of the input/output characteristics of the signal size adjustor 130 of the OFDM optical transmitter 100. For example, when the input/output characteristics of the signal size adjustor 130 of the OFDM optical transmitter 100 are defined by the log function having the parameter corresponding to the value of the input signal as described above, the input/output characteristics of the signal size adjustor 235 of the OFDM optical receiver 200 may be defined by the inverse function of the log function.

The fast Fourier transform unit 240 performs a fast Fourier transform on a data signal from the signal size adjustor 235 to convert the data signal to a signal in a frequency domain. The channel equalizer 245 estimates a channel from a training symbol extracted from the data signal output from the fast Fourier transform unit 240, and performs a channel equalization based on the estimated channel. The symbol demapper 250 performs a symbol demapping on the data signal from the channel equalizer 245 in accordance with a modulation format of the OFDM optical transmitter 100. The parallel-to-serial converter 255 converts a low speed parallel data bit from the symbol demapper 250 to a high speed serial data bit.

The aforementioned OFDM optical transmitter 100 and OFDM optical receiver 200 have been described as an example of a coherent optical transmission/reception system, and the I/Q modulator 150 and the I/Q demodulator 210 can be replaced with other optical modules for performing the same functions as those of the I/Q modulator 150 and the I/Q demodulator 210.

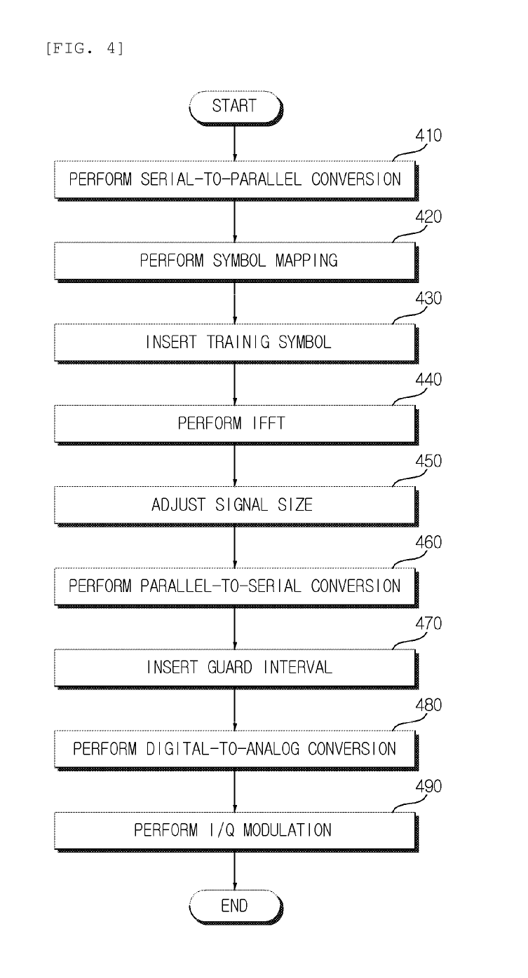

FIG. 4 is a flowchart of an OFDM optical transmission method according to an exemplary embodiment of the present invention. The OFDM optical transmission method according to the exemplary embodiment includes processes performed by the OFDM optical transmitter 100. Accordingly, although matters discussed in connection with the OFDM optical transmitter 100 are omitted in the following description, the matters can be applied to the OFDM optical transmission method according to the exemplary embodiment of the present invention.

In step 410, the serial-to-parallel converter 110 converts an input high speed serial data bit to a low speed parallel data bit.

In step 420, the symbol mapper 115 rearranges data bits included in each data signal, and then performs symbol mapping on the rearranged data bits according to a preset modulation format.

In step 430, the training symbol inserter 120 inserts a training symbol in each of plural data signals to which the data bits are mapped.

In step 440, the inverse fast Fourier transform unit 125 performs an inverse fast Fourier transform on the data signal output from the training symbol inserter 120 to convert the data signal to a signal in a time domain.

In step 450, the signal size adjustor 130 amplifies plural data signals, which are modulated based on the OFDM scheme, output from the inverse fast Fourier transform unit 125 with different amplification rates according to sizes of the data signals.

In step 460, the parallel-to-serial converter 135 converts a low speed parallel data signal output from the signal size adjustor 130 to a high speed serial data signal.

In step 470, the guard interval inserter 140 inserts a guard interval in the data signals output from the parallel-to-serial converter 135.

In step 480, the digital-to-analog converter 145 converts a serial data signal from the guard interval inserter 140 to an analog signal.

In step 490, the I/Q modulator 150 performs an optical modulation on an I (Inphase) component and a Q (Quadrature) component of the analog signal output from the digital-to-analog converter 145 to output an optical signal.

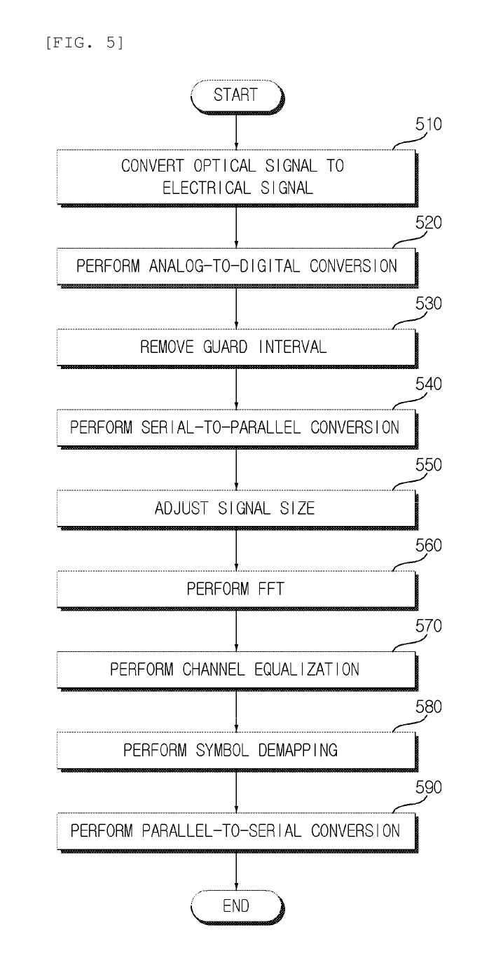

FIG. 5 is a flowchart of an OFDM optical reception method according to an exemplary embodiment of the present invention. The OFDM optical reception method according to the exemplary embodiment of the present invention includes processes performed by the above described OFDM optical receiver 200. Accordingly, although matters discussed in connection with the OFDM optical receiver 200 are omitted in the following description, the matters can be applied to the OFDM optical reception method according to the exemplary embodiment of the present invention.

In step 510, the I/Q demodulator 210 converts a received optical signal to an I (Inphase) signal and a Q (Quadrature) signal corresponding to electrical signals by using the light source 215.

In step 520, a high speed serial data signal is output by sampling an analog signal from the I/Q demodulator 210.

In step 530, the guard interval remover 225 removes a guard interval inserted by a transmission side from an input serial data signal.

In step 540, the serial-to-parallel converter 230 converts a high speed serial data signal output from the guard interval remover 225 to a low speed parallel data signal.

In step 550, the signal size adjustor 235 amplifies the plural data signals output from the serial-to-parallel converter 230 with different amplification rates according to sizes of the data signals so that the adjustment of the sizes of the data signals corresponds to the adjustment of the sizes of the data signals by the signal size adjustor 130 of the OFDM optical transmitter 100.

In step 560, the fast Fourier transform unit 240 performs a fast Fourier transform on a data signal from the signal size adjustor 235, and accordingly the data signal is converted to a signal in a frequency domain.

In step 570, the channel equalizer 245 performs a channel equalization on the data signal output from the fast Fourier transform unit 240.

In step 580, the symbol demapper 250 performs a symbol demapping on the data signal from the channel equalizer 245 according to a modulation format of the OFDM optical transmitter 100.

In step 590, the parallel-to-serial converter 255 converts a low speed parallel data bit from the symbol demapper 250 to a high speed serial data bit.

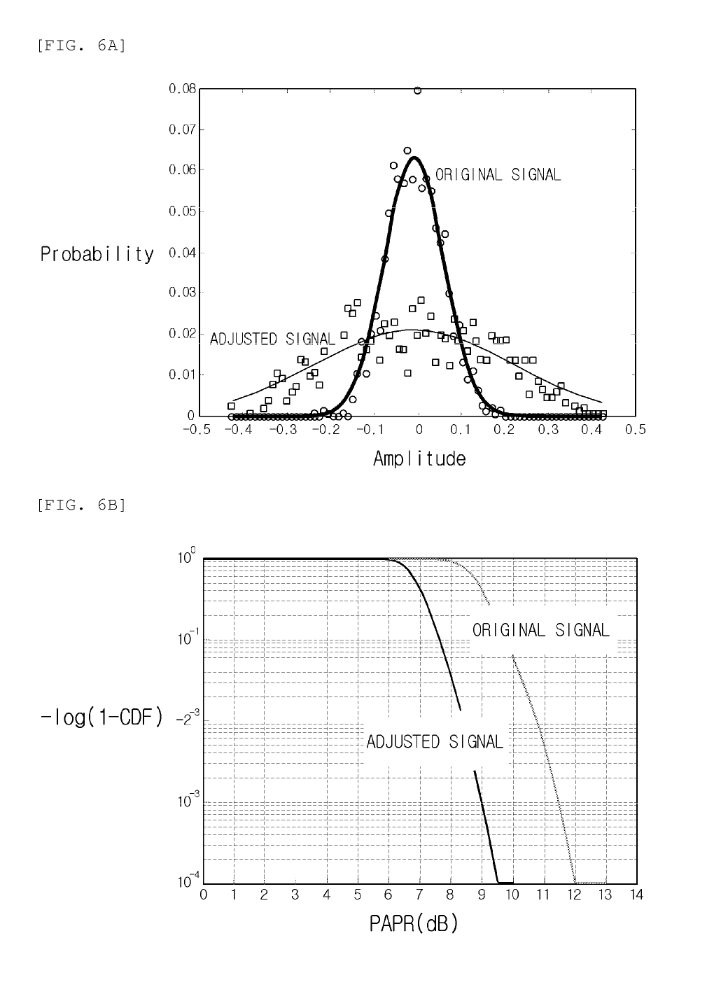

FIG. 6A illustrates probability distributions of sizes of OFDM signals before and after the sizes of the signals are adjusted using the signal size adjustor 130 according to the above described embodiment of the present invention. Referring to FIG. 6A, it can be identified that a distribution of small sized signals is decreased and a distribution of large sized signals is increased in comparison with a case before the sizes of the signals are adjusted. That is, as a result of the adjustment of the sizes of the signals, a distribution of the OFDM signals is flatter.

FIG. 6B illustrates a complementary cumulative distribution function (CCDF) graph showing peak-to-average power ratios (PAPRs) when the signal size adjustor 130 is not applied and is applied according to exemplary embodiments of the present invention. As shown in FIG. 6A, as a result of the adjustment of the sizes of the signals, the distribution of the OFDM signals becomes flatters, and the peak-to-average power ratio is reduced as shown in FIG. 6B. Accordingly, when an optical signal is transmitted along an optical line, the peak power is more decreased in comparison with the average power, and thus a nonlinear phenomenon within an optical fiber can be reduced.

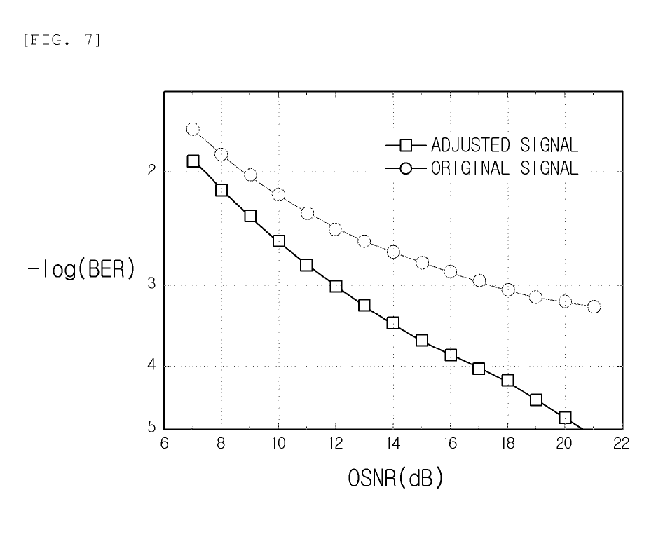

FIG. 7 illustrates a capability of a signal measured after an OFDM signal is transmitted 1,040 km through a single mode optical fiber according to the above described exemplary embodiments of the present invention. In an experiment, a QPSK is used as a modulation scheme and a sampling speed is 10 GS/s. Referring to FIG. 7, it can be identified that approximately 6 dB of an optical signal to noise ratio (OSNR) is improved in 10⁻³ BER (bit error rate) by adjusting the sizes of the signals.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An orthogonal frequency division multiplexing (OFDM) optical transmitter comprising:
a signal size adjustor for amplifying plural data signals modulated based on an OFDM scheme with different amplification rates so that each data signal is amplified according to a size of the corresponding data signal.

2. The OFDM optical transmitter of claim 1, wherein the amplification rate is relatively smaller as the size of the data signal is larger.

3. The OFDM optical transmitter of claim 1, wherein input/output characteristics of the signal size adjustor are defined by a log function having a parameter corresponding to a value of an input signal.

4. The OFDM optical transmitter of claim 1, further comprising:
a serial-to-parallel converter for converting a serial data bit to a parallel data bit;
a symbol mapper for performing symbol mapping on the parallel data bit;
a training symbol inserter for inserting a training symbol in each of the plural data signals to which the parallel data bit is mapped; and
an inverse fast Fourier transform unit for performing an inverse fast Fourier transform on the data signal in which the training symbol is inserted.

5. The OFDM optical transmitter of claim 4, wherein the signal size adjustor amplifies data signals output from the inverse fast Fourier transform unit.

6. The OFDM optical transmitter of claim 5, further comprising:
a parallel-to-serial converter for converting a parallel data signal output from the signal size adjustor to a serial data signal;
a guard interval inserter for inserting a guard interval in a data signal output from the parallel-to-serial converter; and
a digital-to-analog converter for converting a data signal output from the guard interval inserter to an analog signal.

7. An OFDM optical receiver comprising:
a signal size adjustor for amplifying data signals converted to electrical signals from received optical signals modulated based on an OFDM scheme with different amplification rates so that each of the data signals is amplified according to a size of the corresponding data signal.

8. The OFDM optical receiver of claim 7, wherein the amplification rate is relatively larger as the size of the data signal is larger.

9. The OFDM optical receiver of claim 7, wherein input/output characteristics of the signal size adjustor are defined by an inverse function of a log function having a parameter corresponding to a value of an input signal.

10. The OFDM optical receiver of claim 7, further comprising:
an analog-to-digital converter for performing an analog-to-digital conversion on the signal converted to the electrical signal from the modulated optical signal to output a serial data signal;
a guard interval remover for removing a guard interval from the serial data signal; and
a serial-to-parallel converter for converting a serial data signal output from the guard interval remover to a parallel data signal.

11. The OFDM optical receiver of claim 10, wherein the signal size adjustor amplifies data signals output from the serial-to-parallel converter.

12. The OFDM optical receiver of claim 11, further comprising:
a fast Fourier transform unit for performing a fast Fourier transform on a data signal output from the signal size adjustor;
a channel equalizer for performing a channel equalization on a data signal output from the fast Fourier transform unit;
a symbol demapper for performing a symbol demapping on a data signal output from the channel equalizer; and
a parallel-to-serial converter for converting a parallel data bit from the symbol demapper to a serial data bit.

13. An OFDM optical transmission method comprising:
generating plural data signals modulated based on an OFDM scheme; and
amplifying the plural data signals with different amplification rates so that each of the data signals is amplified according to a size of the corresponding data signal.

14. The OFDM optical transmission method of claim 13, wherein the amplification rate is relatively smaller as the size of the data signal is larger.

15. The OFDM optical transmission method of claim 13, wherein the amplifying of the plural data signals includes amplifying each of the data signals according to input/output characteristics defined by a log function having a parameter corresponding to a value of an input signal.

16. An OFDM optical reception method comprising:
receiving optical signals modulated based on an OFDM scheme; and
amplifying data signals converted to electrical signals from the received optical signals with different amplification rates so that each of the data signals is amplified according to a size of the corresponding data signal.

17. The OFDM optical reception method of claim 16, wherein the amplification rate is relatively larger as the size of the data signal is larger.

18. The OFDM optical reception method of claim 16, wherein the amplifying of the data signals includes amplifying each of the data signals according to input/output characteristics defined by an inversed function of a log function having a parameter corresponding to a value of an input signal.

19. The OFDM optical reception method of claim 16, further comprising:
performing a fast Fourier transform on the amplified data signals; and
performing a symbol demapping on the fast Fourier transformed data signals.
